(19) United States
(12) Patent Application Publication
(10) Pub. No.: US 2018/0313489 A1
(43) Pub. Date: Nov. 1, 2018

(54) ABRASION RESISTANT HOSE

(71) Applicant: GM GLOBAL TECHNOLOGY OPERATIONS LLC, Detroit, MI (US)

(72) Inventor: Dennis M. D'hondt, Ray, MI (US)

(73) Assignee: GM GLOBAL TECHNOLOGY OPERATIONS LLC, Detroit, MI (US)

(21) Appl. No.: 15/497,978

(22) Filed: Apr. 26, 2017

(51) Int. Cl. F16L 57/06; F16L 11/08; F16L 11/12

(52) U.S. Cl. CPC F16L 57/06; F16L 11/125; F16L 11/085

(57) ABSTRACT

A hose assembly includes an inner elastomer layer concentric with a centerline, and a fiber reinforcement layer disposed adjacent to and radially outward of the inner elastomer layer. The fiber reinforcement layer may have multiple fiber layers separated by a respective elastomer layer. An intermediate elastomer layer is disposed adjacent to and radially outward of the fiber reinforcement layer. An outer layer is disposed adjacent to and radially outward of the intermediate elastomer layer. The outer layer is an elastomer having a high carbon-black content. The outer layer includes a minimal thickness in order to maintain flexibility of the hose assembly.

### INTRODUCTION

The disclosure generally relates to a hose assembly.

Hose assemblies, particularly flexible hose assemblies used in vehicles and other mechanisms, may be subject to extreme conditions. The hose assemblies may be used for conveying fluids, such as power steering fluid, brake fluid, liquid fuels, diesel emission fluid, engine oil, transmission fluid, AC refrigerant, etc. The hose assemblies often must be capable of withstanding high internal fluid pressures, and should resist wear and/or abrasion so as to maintain operability, and prevent leaks.

### SUMMARY

A hose assembly is provided. The hose assembly includes an inner hose structure and an outer layer. The inner hose structure is concentric with a centerline. The outer layer is disposed adjacent to and radially outward of the inner hose structure relative to the centerline. The outer layer is an elastomer having a carbon-black content of at least 45% by weight.

In one aspect of the disclosure, the outer layer of the hose assembly includes a radial thickness. The radial thickness is measured relative to the centerline, and may vary between 0.5 mm and 5.0 mm. In another aspect of the disclosure, the outer layer is one of: a chlorosulfonated polyethylene (CSM), a chlorinated polyethylene (CM), an ethylene acrylic (AEM), a polyacrylate (ACM), or an ethylene vinyl acetate copolymer (EVM).

In one aspect of the disclosure, the intermediate elastomer layer is one of: a chlorosulfonated polyethylene (CSM), a chlorinated polyethylene (CM), an ethylene acrylic (AEM), a polyacrylate (ACM), or an ethylene vinyl acetate copolymer (EVM).

In another aspect of the disclosure, the inner elastomer layer is one of: a nitrile rubber (NBR), a chlorotrifluoroethylenevinylidene fluoride (FKM), a perfluoroelastomer (FFKM), a tetrafluoro ethylene/propylene (FEPM), a polyethylenetetrafluoroethylene (ETFE), fluorocarbon thermoplastic vulcanizate (FTPV), a tetrafluoroethylene hexafluoropropylene vinylidene (THV), a chlorosulfonated polyethylene (CSM), a chlorinated polyethylene (CM), an ethylene acrylic (AEM), a polyacrylate (ACM), a hydrogenated nitrile rubber (HNBR), or an ethylene vinyl acetate copolymer (EVM).

In another aspect of the disclosure, the fiber reinforcement layer may include one of aramid fibers, nylon fibers, or polyester fibers. The fiber reinforcement layer may include a plurality of individual fiber layers, with each radially adjacent pair of individual fiber layers separated by a respective elastomer layer. Each of the respective elastomer layers separating the adjacent pairs of individual fiber layers may include one of: natural rubber (NR), iIsoprene (IR), ethylene propylene diene (EPDM), nitrile rubber (NBR), styrene butadiene (SBR), butyl rubber (IIR), hydrogenated nitrile (HNBR), chlorosulfonated polyethylene (CSM), chlorinated polyethylene (CM), acrylic ester/ethylene (AEM), polyacrylate (ACM), or ethylene vinyl acetate copolymer (EVM).

In one embodiment of the hose assembly, the inner elastomer layer and the intermediate elastomer layer are each an elastomer that is heat resistant up to a temperature of at least 120° C. Furthermore, the inner elastomer layer and the intermediate elastomer layer may each include an elastomer that is chemically resistant to at least one of: a power steering fluid, a brake fluid, an engine oil, a transmission fluid, a liquid fuel, a diesel emission fluid, an AC refrigerant, or a hydraulic fluid.

Accordingly, the outer layer of the hose assembly includes an elastomer having a high carbon-black content, which provides an abrasion resistant layer to the outer surface of the hose assembly. The highly abrasion resistant outer layer precludes the need to place a sleeve over the hose assembly to protect the hose assembly from wear and/or abrasion.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a hose assembly with layers removed for visibility.

FIG. 2 is a schematic cross sectional view of a fiber reinforcement layer of the hose assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a hose assembly is generally shown at 20. The hose assembly 20 includes an inner hose structure 22 that is covered by an outer layer 24. The hose assembly 20 is concentric with and extends along a centerline 26. The inner hose structure 22 includes an inner elastomer layer 28, a fiber reinforcement layer 30, and an intermediate elastomer layer 32.

The inner elastomer layer 28 is concentric with the centerline 26, and is the internal lining of the hose assembly 20. The inner elastomer layer 28 is an elastomer that is chemically resistant to the fluid that the hose assembly 20 is intended to convey. Chemical resistance is the strength of a material to protect against chemical attack or solvent reaction. Chemical resistance is the opposite of chemical reactivity, and determines a material's resistivity to corrosive environments. As used herein, the term “chemically resistant” is defined as being substantially non-reactive with a specific solvent, and as the ability of a material to maintain its chemical and structural integrity over time when exposed to that specific solvent. Accordingly, the inner elastomer layer 28 will include and be manufactured from an elastomer that is chemically resistant to the fluid that the hose assembly 20 is intended to convey. Exemplary fluids may include, but are not limited to: a power steering fluid, a liquid fuel such as but not limited to gasoline, diesel fuel, biodiesel, ethanol, etc., a diesel emission fluid, a brake fluid, a motor oil, a transmission fluid, an AC refrigerant, a hydraulic fluid, etc. It should be appreciated that the hose assembly 20 may be used in any mechanism. As such, the fluids that the hose assembly 20 may be used to convey should not be limited to the exemplary fluids noted herein. Therefore, the inner elastomer layer 28 may be chemically resistant to some other chemical or fluid not described herein.

Additionally, the inner elastomer layer 28 may include and be manufactured from an elastomer that is heat resistant up to a pre-defined temperature. As used herein, the term “heat resistant” is defined as the ability of an object to maintain its shape and chemical composition up to a pre-defined temperature. Temperatures greater than the pre-defined temperature may cause the object to lose structural integrity, e.g., melt, or become chemically reactive. For example, if the hose assembly 20 is to be used in an engine compartment of a vehicle, the inner elastomer layer 28 may be manufactured from an elastomer that is heat resistant up to a temperature of at least 120° C., so as to maintain its shape and chemical resistance during normal vehicular operation. In other embodiments, the inner elastomer layer 28 may need to be manufactured from an elastomer that is heat resistant up to a temperature of approximately 200° C. It should be appreciated that the heat resistance of the hose assembly 20 may vary with the intended application of the hose assembly 20, and that the heat resistance of the inner elastomer layer 28 may vary from the exemplary embodiments described above. Furthermore, in other embodiments, the hose assembly 20 may not need to be heat resistant, and the inner elastomer layer 28 may be manufactured from an elastomer that is not particularly heat resistant.

As noted above, the inner elastomer layer 28 may include any elastomer that is chemically resistant to the fluid for which the hose assembly 20 is intended to convey, and is heat resistant to a temperature suited for the intended environment in which the hose assembly 20 is to be used. For example, the inner elastomer layer 28 may include and be manufactured from one of, but is not limited to: a nitrile rubber (NBR), a chlorotrifluoroethylenevinylidene fluoride (FKM), a perfluoroelastomer (FFKM), a tetrafluoro ethylene/propylene (FEPM), a polyethylenetetrafluoroethylene (ETFE), Fluorocarbon Thermoplastic Vulcanizate (FTPV), a tetrafluoroethylene hexafluoropropylene vinylidene (THV), a chlorosulfonated polyethylene (CSM), a chlorinated polyethylene (CM), an ethylene acrylic (AEM), a polyacrylate (ACM), a hydrogenated nitrile rubber (HNBR), or an ethylene vinyl acetate copolymer (EVM).

The inner elastomer layer 28 may include a radial thickness 34 measured relative to the centerline 26 that is between 0.5 mm and 5.0 mm. It should be appreciated that the radial thickness 34 of the inner elastomer layer 28 may vary from the exemplary range noted above, and will depend upon the specific intended use of the hose assembly 20.

The fiber reinforcement layer 30 is disposed adjacent to and radially outward of the inner elastomer layer 28, relative to the centerline 26. The fiber reinforcement layer 30 includes at least one layer of fibers. The fibers may include, but are not limited to aramid fibers, nylon fibers, polyester fibers, etc. The specific type of fibers used to form the fiber reinforcement layer 30 is dependent upon the specific application of the hose assembly 20.

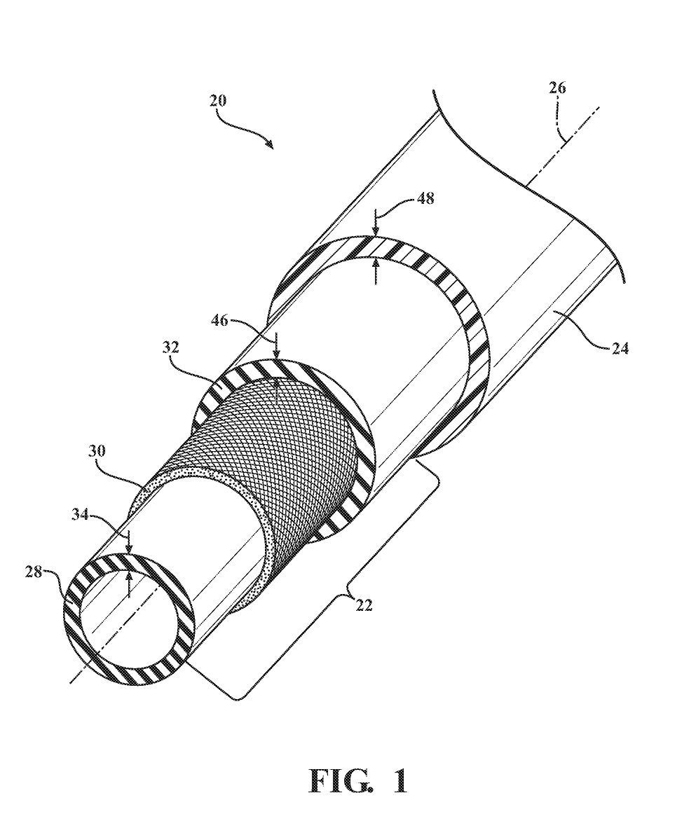

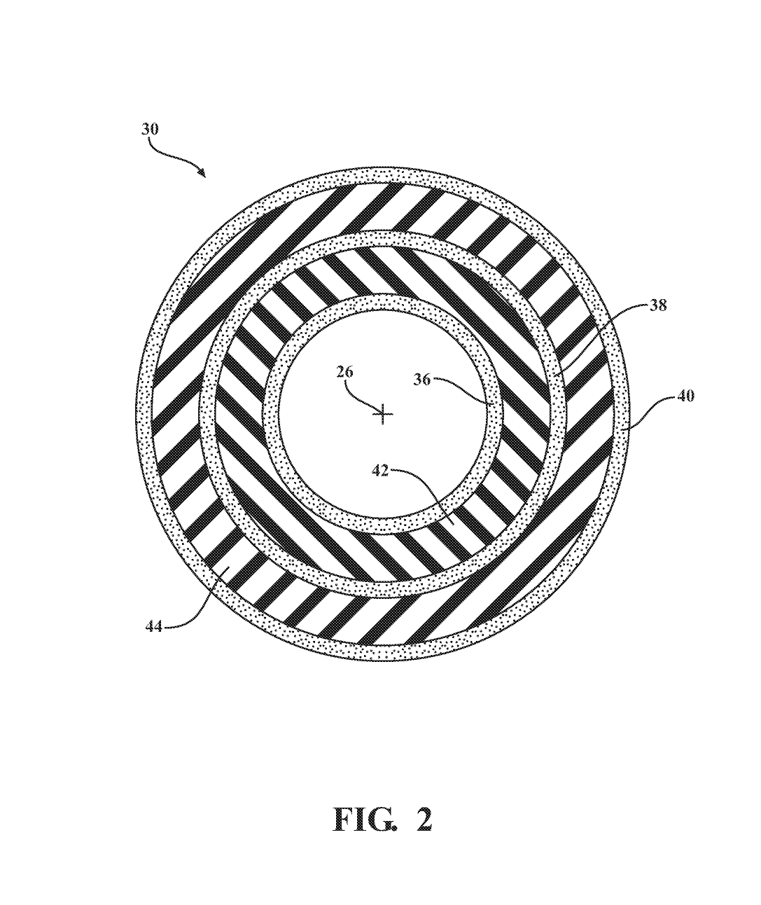

Depending upon the amount of fluid pressure the hose assembly 20 is intended to constrain, the fiber reinforcement layer 30 may include a single fiber layer, such as shown in FIG. 1, or may include multiple fiber layers, such as shown in FIG. 2. In other words, referring to FIG. 2, the fiber reinforcement layer 30 may include a plurality of individual fiber layers, with each radially adjacent pair of individual fiber layers separated by a respective elastomer layer. As shown in the exemplary embodiment of the fiber reinforcement layer 30 in FIG. 2, the fiber reinforcement layer 30 includes a first fiber layer 36, a second fiber layer 38, and a third fiber layer 40. The first fiber layer 36 and the second fiber layer 38 are separated by a first elastomer layer 42. The second fiber layer 38 and the third fiber layer 40 are separated by a second elastomer layer 44. The total number of fiber layers and respective elastomer layers separating the adjacent pairs of fiber layers may differ from the exemplary multi-layered embodiment shown in FIG. 2. Each of the respective elastomer layers separating the adjacent pairs of individual fiber layers may include and be manufactured from one of, but is not limited to: natural rubber (NR), iIsoprene (IR), ethylene propylene diene (EPDM), nitrile rubber (NBR), styrene butadiene (SBR), butyl rubber (IIR), hydrogenated nitrile (HNBR), chlorosulfonated polyethylene (CSM), chlorinated polyethylene (CM), acrylic ester/ethylene (AEM), polyacrylate (ACM), or ethylene vinyl acetate copolymer (EVM).

The intermediate elastomer layer 32 is disposed adjacent to and radially outward of the fiber reinforcement layer 30, relative to the centerline 26. The intermediate elastomer layer 32 is an elastomer that is chemically resistant to the fluid that the hose assembly 20 is intended to convey. As described above, the term “chemically resistant” is defined as being substantially non-reactive with a specific solvent, and as the ability of a material to maintain its chemical and structural integrity over time when exposed to that specific solvent. Accordingly, the intermediate elastomer layer 32 includes and is manufactured from an elastomer that is chemically resistant to the fluid that the hose assembly 20 is intended to convey. Exemplary fluids may include, but are not limited to: a power steering fluid, a liquid fuel such as but not limited to gasoline, diesel fuel, biodiesel, ethanol, etc., a diesel emission fluid, a brake fluid, an engine oil, a transmission fluid, an AC refrigerant, a hydraulic fluid, etc. It should be appreciated that the hose assembly 20 may be used in any mechanism. As such, the fluids that the hose assembly 20 may be used to convey should not be limited to the exemplary fluids described herein. Therefore, the intermediate elastomer layer 32 may be chemically resistant to some other chemical or fluid not described herein.

Additionally, the intermediate elastomer layer 32 may include and be manufactured from an elastomer that is heat resistant up to a pre-defined temperature. As described above, the term “heat resistant” is defined as the ability of an object to maintain its shape and chemical composition up to a pre-defined temperature. Temperatures greater than the pre-defined temperature may cause the object to lose structural integrity, e.g., melt, or become chemically reactive. For example, if the hose assembly 20 is to be used in an engine compartment of a vehicle, the intermediate elastomer layer 32 may be manufactured from an elastomer that is heat resistant up to a temperature of at least 120° C., so as to maintain its shape and chemical resistance during normal vehicular operation. In other embodiments, the intermediate elastomer layer 32 may need to be manufactured form an elastomer that is heat resistant up to a temperature of approximately 200° C. It should be appreciated that the required heat resistance of the hose assembly 20 may vary with the intended application of the hose assembly 20, and that the heat resistance of the intermediate elastomer layer 32 may vary from the exemplary embodiment described above. Furthermore, in other embodiments, the hose assembly 20 may not need to be heat resistant, and the intermediate elastomer layer 32 may be manufactured from an elastomer that is not particularly heat resistant.

As noted above, the intermediate elastomer layer 32 may include any elastomer that is chemically resistant to the fluid for which the hose assembly 20 is intended to convey, and is heat resistant to a temperature suited for the intended environment in which the hose assembly 20 is to be used. For example, the intermediate elastomer layer 32 may include and be manufactured from one of, but is not limited to: a chlorosulfonated polyethylene (CSM), a chlorinated polyethylene (CM), an ethylene acrylic (AEM), a polyacrylate (ACM), or an ethylene vinyl acetate copolymer (EVM).

The intermediate elastomer layer 32 may include a radial thickness 46 measured relative to the centerline 26 that is between 0.5 mm and 5.0 mm. It should be appreciated that the radial thickness 46 of the intermediate elastomer layer 32 may vary from the exemplary ranges noted above, and will depend upon the specific intended use of the hose assembly 20.

The outer layer 24 is disposed adjacent to and radially outward of the intermediate elastomer layer 32, relative to the centerline 26. The outer layer 24 is an elastomer. The outer layer 24 may include and be manufactured from, but is not limited to: a chlorosulfonated polyethylene (CSM), a chlorinated polyethylene (CM), an ethylene acrylic (AEM), a polyacrylate (ACM), or an ethylene vinyl acetate copolymer (EVM).

The elastomer of the outer layer 24 includes a carbon-black content. In some embodiments, the carbon-black content is at least forty five percent by weight, i.e., the carbon-black content is equal to or greater than 45% by weight. Carbon-black is a form of paracrystalline carbon that has a high surface-area-to-volume ratio. The specific type of carbon-black, and the amount of carbon-black included in the elastomer of the outer layer 24, is dependent upon the specific elastomer formulation used for the outer layer 24, and the specific application that the hose assembly 20 is intended for. The carbon-black in the outer layer 24 provides a high tensile strength, and resistance to cutting and abrasion, which provides excellent wear and abrasion resistance for the hose assembly 20. In addition, the high tensile strength of the outer layer 24 may help maintain structural integrity of the hose assembly 20 during any crimping processes used to attach the hose assembly 20 to a metal fitting or other tubing. The carbon-black content of the elastomer of the outer layer 24 is much higher than is typically used in elastomers when manufacturing hose assemblies.

The high carbon-black content of the elastomer used for the outer layer 24 increases the stiffness of the outer layer 24, relative to elastomers using no or low levels of carbon-black. Accordingly, the outer layer 24 is designed to have a thin radial thickness 48, relative to the thicknesses of the other layers, to maintain flexibility in the hose assembly 20. The radial thickness 48 is measured relative to the centerline 26, and may be between 0.5 mm and 5.0 mm. It should be appreciated that the radial thickness 48 of the outer layer 24 may vary from the exemplary ranges noted above, and will depend upon the specific intended use of the hose assembly 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A hose assembly comprising:
an inner elastomer layer concentric with a centerline;
a fiber reinforcement layer disposed adjacent to and radially outward of the inner elastomer layer relative to the centerline;
an intermediate elastomer layer disposed adjacent to and radially outward of the fiber reinforcement layer relative to the centerline; and
an outer layer disposed adjacent to and radially outward of the intermediate elastomer layer relative to the centerline;
wherein the outer layer is an elastomer having a carbon-black content of at least forty five percent by weight.

2. The hose assembly set forth in claim 1, wherein the outer layer includes a radial thickness relative to the centerline that is between 0.5 mm and 5.0 mm.

3. The hose assembly set forth in claim 1, wherein the outer layer is one of: a chlorosulfonated polyethylene (CSM), a chlorinated polyethylene (CM), an ethylene acrylic (AEM), a polyacrylate (ACM), or an ethylene vinyl acetate copolymer (EVM).

4. The hose assembly set forth in claim 1, wherein the intermediate elastomer layer is one of: a chlorosulfonated polyethylene (CSM), a chlorinated polyethylene (CM), an ethylene acrylic (AEM), a polyacrylate (ACM), or an ethylene vinyl acetate copolymer (EVM).

5. The hose assembly set forth in claim 1, wherein the inner elastomer layer is one of: a nitrile rubber (NBR), a chlorotrifluoroethylenevinylidene fluoride (FKM), a perfluoroelastomer (FFKM), a tetrafluoro ethylene/propylene (FEPM), a polyethylenetetrafluoroethylene (ETFE), fluorocarbon thermoplastic vulcanizate (FTPV), a tetrafluoroethylene hexafluoropropylene vinylidene (THV), a chlorosulfonated polyethylene (CSM), a chlorinated polyethylene (CM), an ethylene acrylic (AEM), a polyacrylate (ACM), a hydrogenated nitrile rubber (HNBR), or an ethylene vinyl acetate copolymer (EVM).

6. The hose assembly set forth in claim 1, wherein the fiber reinforcement layer includes one of aramid fibers, nylon fibers, or polyester fibers.

7. The hose assembly set forth in claim 1, wherein the fiber reinforcement layer includes a plurality of individual fiber layers, with each radially adjacent pair of individual fiber layers separated by a respective elastomer layer.

8. The hose assembly set forth in claim 7, wherein each of the respective elastomer layers separating the adjacent pairs of individual fiber layers is one of: natural rubber (NR), iIsoprene (IR), ethylene propylene diene (EPDM), nitrile rubber (NBR), styrene butadiene (SBR), butyl rubber (IIR), hydrogenated nitrile (HNBR), chlorosulfonated polyethylene (CSM), chlorinated polyethylene (CM), acrylic ester/ethylene (AEM), polyacrylate (ACM), or ethylene vinyl acetate copolymer (EVM).

9. The hose assembly set forth in claim 1, wherein the inner elastomer layer and the intermediate elastomer layer are each an elastomer that is heat resistant up to a temperature of at least 120° C.

10. The hose assembly set forth in claim 1, wherein the inner elastomer layer and the intermediate elastomer layer are each an elastomer that is chemically resistant to at least one of: a power steering fluid, a brake fluid, an engine oil, a transmission fluid, a liquid fuel, a diesel emission fluid, an AC refrigerant, or a hydraulic fluid.

11. A hose assembly comprising:
an inner hose structure concentric with a centerline; and
an outer layer disposed adjacent to and radially outward of the inner hose structure relative to the centerline;
wherein the outer layer is an elastomer having a carbon-black content equal to or greater than 45% by weight.

12. The hose assembly set forth in claim 11, wherein the outer layer includes a radial thickness relative to the centerline that is between 0.5 mm and 5.0 mm.

13. The hose assembly set forth in claim 11, wherein the inner hose structure includes:
an inner elastomer layer concentric with the centerline;
a fiber reinforcement layer disposed adjacent to and radially outward of the inner elastomer layer relative to the centerline; and
an intermediate elastomer layer disposed adjacent to and radially outward of the fiber reinforcement layer relative to the centerline;
wherein the outer layer is disposed adjacent to and radially outward of the intermediate elastomer layer relative to the centerline.

14. The hose assembly set forth in claim 13, wherein the fiber reinforcement layer includes a plurality of individual fiber layers, with each radially adjacent pair of individual fiber layers separated by a respective elastomer layer.

15. The hose assembly set forth in claim 11, wherein the inner hose structure is an elastomer that is heat resistant up to a temperature of at least 120° C.

16. The hose assembly set forth in claim 11, wherein the inner hose structure is an elastomer that is chemically resistant to at least one of: a power steering fluid, a brake fluid, a liquid fuel, a diesel emission fluid, an engine oil, a transmission fluid, an AC refrigerant, or a hydraulic fluid.
